(19) United States
(12) Patent Application Publication
(10) Pub. No.: US 2006/0045056 A1
(43) Pub. Date: Mar. 2, 2006

(54) Border access point protocol facilitating wireless client macro-mobility

(76) Inventor: Robert B. O'Hara JR., Santa Clara, CA (US)

Correspondence Address: MARK J. SPOLYAR, 38 FOUNTAIN ST., SAN FRANCISCO, CA, 94114, US

(21) Appl. No.: 10/931,160

(22) Filed: Aug. 31, 2004

(51) Int. Cl. H04Q 7/00; H04Q 7/24; H04Q 7/20

(52) U.S. Cl. 370/338; 370/331; 455/436

(57) ABSTRACT

Methods, apparatuses and systems directed to a border access point protocol that facilitates network selection and mobility operations for wireless clients, such as dual-mode wireless telephones and other devices. In one implementation, the present invention provides a wireless network infrastructure comprising a plurality of access points, at least some of which are so-called border access points that provide border information to wireless clients. The border information, in one embodiment, indicates to the wireless client that the transmitting access point is proximal to the perimeter of the intended coverage area of the wireless network infrastructure. In another implementation, the border information indicates that the transmitting access point is proximal to a point of egress from, or ingress to, a coverage area. Wireless clients within range of the border access points can use the border information to facilitate or enhance selection of a network for initiation of a given section, as well as in handoff or other mobility operations between two network types or domains (e.g., a WLAN and a cellular network).

### CROSS-REFERENCE TO RELATED APPLICATIONS

This application makes reference to the following commonly owned U.S. patent applications and/or patents, which are incorporated herein by reference in their entirety for all purposes:

U.S. patent application Ser. No. 10/155,938 in the name of Patrice R. Calhoun, Robert B. O'Hara, Jr. and Robert J. Friday, entitled “Method and System for Hierarchical Processing of Protocol Information in a Wireless LAN;”

U.S. patent application Ser. No. 10/407,357 in the name of Patrice R. Calhoun, Robert B. O”Hara, Jr. and Robert J. Friday, entitled “Method and System for Hierarchical Processing of Protocol Information in a Wireless LAN;”

U.S. patent application Ser. No. 10/611,521 in the name of Patrice R. Calhoun, entitled “Dynamic QoS Configuration Based On Transparent Processing of Session Initiation Messages;” and

U.S. patent application Ser. No. 10/611,522 in the name of Robert J. Friday, entitled “Non-overlapping Antenna Pattern Diversity in Wireless Network Environments.”

### FIELD OF THE INVENTION

The present invention relates to wireless networks and, more particularly, to methods, apparatuses and systems directed to facilitating macro-mobility of wireless clients between different network domains or network types.

### BACKGROUND 0F THE INVENTION

The rapidly expanding WLAN and Voice over Internet Protocol (VoIP) technologies have recently been combined to enable Wi-Fi Telephony, allowing VoIP call sessions over a WLAN infrastructure. The market adoption of wireless LAN (WLAN) technology has exploded, as users from a wide range of backgrounds and vertical industries bring this technology into homes, offices, and increasingly into the public air space. This inflection point highlights not only the limitations of earlier-generation systems, but the changing role WLAN technology now plays in people”s work and lifestyles, across the globe. Indeed, WLANs are rapidly changing from convenience networks to business-critical networks. Increasingly users are depending on WLANs to improve the timeliness and productivity of their communications and applications, and in doing so, require greater visibility, security, management, and performance from their network.

In addition, VoIP telephony has rapidly emerged as a viable and cost-effective alternative to circuit-switched voice networks. In Internet Protocol (IP) networks, particularly in enterprise LANs where bandwidth is ample and network management systems allow for enhanced network traffic control, voice and data traffic can peacefully co-exist on the network. In addition, the ubiquity of IP networks has opened the door to reliable, high-quality voice applications on either wired or wireless networks. Furthermore, the addition of Wi-Fi telephony leverages existing investments in WLANs, while reducing cost and increasing productivity and responsiveness for mobile employees in the workplace.

To take advantage of Wi-Fi telephony, handset manufactures have begun to offer dual-mode telephones and personal digital assistants (PDAs) that provide cellular network and WLAN connectivity for data and voice applications. For example, Texas Instruments, Inc. has introduced WANDA, which stands for Wireless Any-Network Digital Assistant, is a handheld tri-band device that includes chip sets that support 802.11 WLAN, GSM/GPRS and Bluetooth™ connectivity. Other hand set vendors, such as Nokia, Inc.® and Motorola, Inc.®, have also announced similar offerings.

The integration of VoIP over WLAN and cellular network technologies presents certain technical challenges for handset vendors and WLAN infrastructure providers. For example, given the wide ranging mobility of cellular phone handsets and other wireless devices, technology must be developed for identifying available networks (e.g., cellular networks, WLANs, etc.) and choosing between them upon initiation of a given application, such as a voice call. In addition, technology must be developed for facilitating handoffs of an active call or other session between WLAN access points (both intra-domain and inter-domain), as well as between a WLAN access point and the cell or base station of a cellular network. Indeed, development in this area, such as extensions to the Session Initiation Protocol (SIP), Mobile IP, and other technologies is ongoing.

In light of the foregoing, a need in the art exists for methods, apparatuses and systems that support, enable and/or facilitate wireless handset mobility across domains and/or network types. Embodiments of the present invention substantially fulfill this need.

### SUMMARY OF THE INVENTION

The present invention provides methods, apparatuses and systems directed to a border access point protocol that facilitates network selection and mobility operations for wireless clients, such as dual-mode wireless telephones and other devices. In one implementation, the present invention provides a wireless network infrastructure comprising a plurality of access points, at least some of which are so-called border access points that provide border information to wireless clients. The border information, in one embodiment, indicates to the wireless client that the transmitting access point is proximal to the perimeter of the intended coverage area of the wireless network infrastructure. In another implementation, the border information indicates that the transmitting access point is proximal to a point of egress from, or ingress to, a coverage area. Wireless clients within range of the border access points can use the border information to facilitate or enhance selection of a network for initiation of a given section, as well as in handoff or other mobility operations between two network types or domains (e.g., a WLAN and a cellular network).

### DESCRIPTION OF THE DRAWINGS

FIG. 1 is a schematic diagram of a physical space including a plurality of wireless access points positioned at various locations within the space.

FIG. 2 is a functional block diagram showing a wireless network architecture, according to one implementation of the invention, in which the border access point functionality may be implemented.

FIG. 3 is a functional block diagram illustrating an alternative wireless network system architecture in which the present invention may operate.

FIG. 4 is a functional block diagram providing different VoIP over WLAN system architectures.

FIGS. 5A-5C are flow chart diagrams illustrating methods, according to various possible implementations of the invention, incorporating border information in the selection of a network for a new session.

FIGS. 5D and 5E are flow chart diagrams providing methods, according to one implementation of the invention, directed to handoff operations that incorporate border information in their decisional logic.

FIG. 6 is a schematic diagram illustrating a portal and a plurality of proximally-located border access points.

### DESCRIPTION OF PREFERRED EMBODIMENT(S)

A. Operating Environment

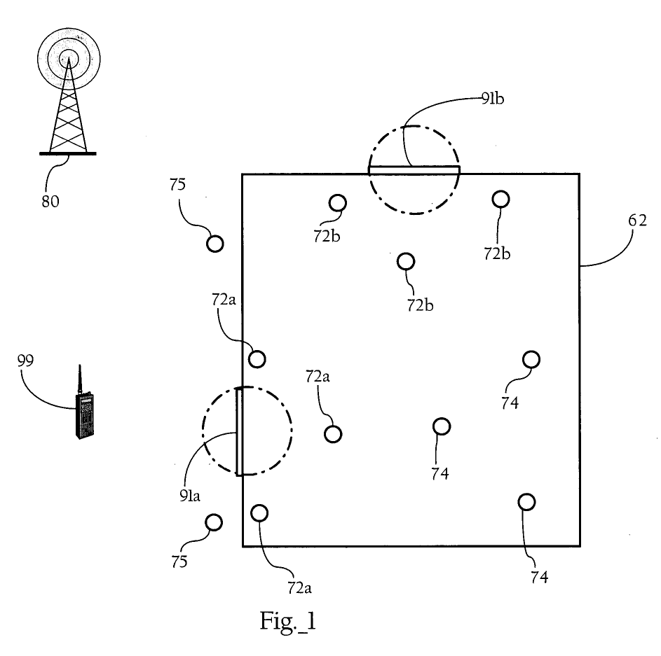

FIG. 1 is a schematic diagram illustrating an enclosed physical space 62 including a plurality of access points 72, 74 positioned at various locations within the physical space 62 to provide wireless network access to one or more wireless clients. As FIG. 1 illustrates, the physical space 62 includes portals 91a, 91b providing points of ingress to, and egress from, the physical space 62, such as doorways, entrance ways, hallways, entrance gates, and the like. In one implementation, portals are points of egress from and ingress to any intended physical area over which a plurality of wireless access points are deployed to provide radio coverage. As FIG. 1 illustrates, border access points 72a, 72b are proximal to portals 91a, 91b respectively, while access points 74 are deployed at other locations within the physical space 62. Physical space 62 may be an enclosed indoor physical space, such as an office building, or an outdoor environment whether or not it is actually physically enclosed. In one implementation, border access points need not be located proximally to a portal and can merely be located proximal to the perimeter of a physical space where there is little to no physical restrictions on egress or ingress.

FIG. 1 further shows a dual-mode wireless client 99, such as a dual-mode cellular telephone, capable of communicating in a first mode with a cellular network, via a base station 80 or cell tower, and in a second mode with a wireless network infrastructure, via wireless access points 72a, 72b and 74. The cellular network may implement any of a variety of wireless transmission methods, such as GSM, CDMA, TDMA, and the like. The dual-mode wireless client 99, in one implementation, further includes wireless LAN functionality that allows for communication with wireless access points. In one embodiment, dual-mode wireless client 99, and wireless access points 72a, 72b and 74, implement the 802.11 wireless network protocol (where 802.11, as used herein, generically refers to the IEEE 802.11 standard for wireless LANs and all its amendments). In one embodiment, the WLAN functionality described herein can be implemented in a wireless network interface chip set, such as an 802.11 network interface chip set. Of course, the present invention can be used in connection with any suitable radio-frequency-based wireless network protocol. In some implementations, dual-mode wireless client 99 may further include other call and network-related functionality, such as a Dynamic Host Control Protocol (DHCP) client, VoIP functionality that digitizes and packetizes voice signals, as well as call control and/or signaling functionality (e.g., interoperability with H.323, Session Initiation Protocol (SIP), Media Gateway Control Protocol (MGCP), Skinny Client Control Protocol (SCCP), etc.). As discussed more fully below, dual-mode wireless client 99 also includes access mode selection logic that incorporates information, if any, transmitted by border access points 72a, 72b in the selection of cellular network or WLAN connectivity for VoIP or other sessions. In one implementation, dual-mode wireless client 99 also includes functionality supporting handoffs between the cellular network and a WLAN during a session, such as a phone call.

For didactic purposes an embodiment of the present invention is described as operating in connection with a WLAN environment as disclosed in U.S. application Ser. Nos. 10/155,938 and 10/407,357 incorporated by reference herein. As discussed below, however, the present invention can be implemented according to a vast array of embodiments, and can be applied to a variety of WLAN architectures.

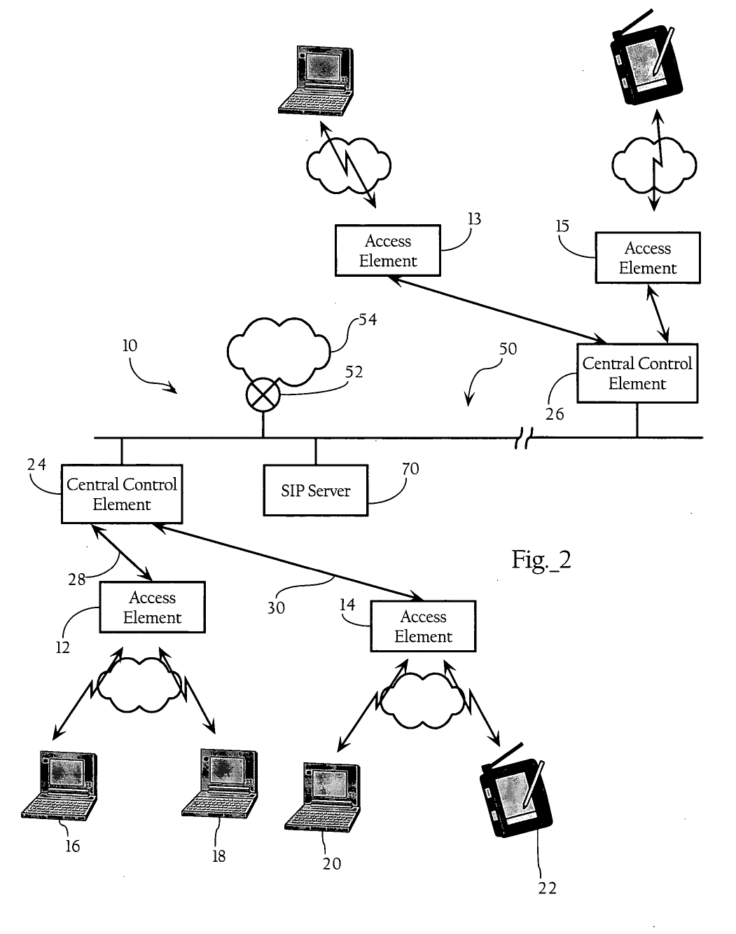

FIG. 2 illustrates a wireless computer network topology according to an embodiment of the present invention. Referring to FIG. 2, there is shown a block diagram of a wireless Local Area Network system 10 according to an embodiment of the invention. A specific embodiment of the invention includes the following elements: access elements 12, 14 for wireless communication with selected client remote elements 16, 18, 20, 22, central control elements 24, 26, and means for communication between the access elements and the central control elements, typically direct line access 28, 30, but potentially a wireless backbone, fiber or other reliable link. As disclosed in U.S. patent application Ser. No. 10/407,357, in another embodiment, the access elements, such as access elements 12, 14 are directly connected to LAN 10 or a virtual local area network (VLAN) for communication with a corresponding central control element 24, 26.

The access elements 12-15 are coupled via communication means using a wireless local area network (WLAN) protocol (e.g., IEEE 802.11a or 802.11b, etc.) to the client remote elements 16, 18, 20, 22. The communications means 28, 30 between the access elements 12, 14 and the central control element 24 is typically an Ethernet network, but it could be anything else which is appropriate to the environment. As described in U.S. application Ser. No. 10/155,938, the access elements 12, 14 and the central control element 24 tunnel network traffic associated with corresponding remote client elements 16, 18; 20, 22 via direct access lines 28 and 30, respectively. Central control element 24 is also operative to bridge the network traffic between the remote client elements 16, 18; 20, 22 transmitted through the tunnel with corresponding access elements 12, 14.

As described in the above-identified patent applications, central control element 24 operates to perform data link layer management functions, such as authentication and association on behalf of access elements 12, 14. For example, the central control element 24 provides processing to dynamically configure a wireless Local Area Network of a system according to the invention while the access elements 12, 14 provide the acknowledgment of communications with the client remote elements 16, 18, 20, 22. The central control element 24 may for example process the wireless LAN management messages passed on from the client remote elements 16, 18; 20, 22 via the access elements 12, 14, such as authentication requests and authorization requests, whereas the access elements 12, 14 provide immediate acknowledgment of the communication of those messages without conventional processing thereof. Similarly, the central control element 24 may for example process physical layer information. Still further, the central control element 24 may for example process information collected at the access elements 12, 14 on channel characteristic, propagation, and interference or noise. on the other hand, access elements 12, 14 may be configured to transmit beacon packets' and probe response frames automatically without intervention or control by a central control element 24. Central control elements 25, 26 and associated access elements 13, 15 operate in a similar or identical manner. Other system architectures are possible. For example, U.S. application Ser. No. 10/407,357 discloses a system architecture where the access elements, such as access elements 12-15, are directly connected to LAN segment 10.

SIP server 70, in one embodiment, is a call control node hosting functionality for facilitating the initiation of sessions between two end-systems. In one embodiment, SIP server 70 includes authentication mechanisms to identify and authenticate users to allow or deny access to the session initiation functionality. In one embodiment, SIP server 70 includes or is operably connected to a user database storing user names in association with corresponding passwords to allow for authentication of users based on password. SIP server 70 includes registration and session initiation functionality. Registration functionality allows users to register with SIP server 70 to allow incoming session requests to be connected with the user. Session initiation functionality allows the user to initiate sessions with one or more end systems. Mobile stations, such as remote client elements 16, 18, 20, 22 and dual-mode wireless client 99, in one implementation, include a SIP client operative to interact with SIP server 70. In one embodiment, the SIP server 70 and the SIP clients implement the Session Initiation Protocol (SIP), initially specified in IETF RFC 2543. One skilled in the art will recognize that other suitable session initiation, call or application signaling protocols can be used, such as H.323. In one embodiment, the remote client elements 16, 18, 20, 22 include an application that interacts with remote client elements by exchanging data or multimedia elements over a computer network. For example, the remote client elements 16, 18, 20, 22 may include a telephony application that uses the SIP client residing on each remote client element to establish the session during which voice data, or voice and video data, are exchanged between remote client elements.

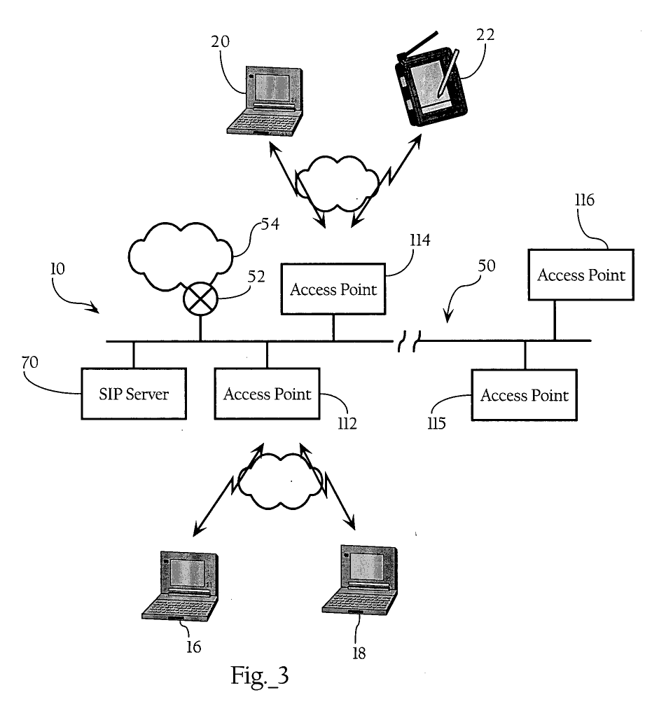

Implementations of the present invention can be incorporated into other wireless network system architectures. FIG. 3 illustrates another wireless network system architecture comprising a plurality of substantially autonomous access points 112-116, at least some of which are configured as border access points to transmit the border information described herein.

Generally, the functionality of the access points or access elements comprises a radio transceiver or radio module and a link layer control unit. In one embodiment, the WLAN functionality described herein can be implemented in a wireless network interface chip set, such as an 802.11 network interface chip set. Radio module 30 includes frequency-based modulation/demodulation functionality for, in the receive direction, demodulating radio frequency signals and providing digital data streams, and in the transmit direction, receiving digital data streams and providing frequency modulated signals corresponding to the digital data stream. In one embodiment, a suitable transceiver includes an Orthogonal Frequency Division Multiplexed modulation/demodulation unit. In one embodiment, the transceiver implements the OFDM functionality in a manner compliant with the IEEE 802.11a and 802.11g protocol. Of course, other frequency modulation protocols may be employed. A link layer control unit implements data link layer functionality, such as detecting individual frames in the digital data streams, error checking the frames, transmitting beacon frames or packets on a regular basis, responding to probe requests, and the like. In one embodiment, the link layer control unit implements the IEEE 802.11 wireless network protocol. Other suitable wireless protocols can be used in the present invention.

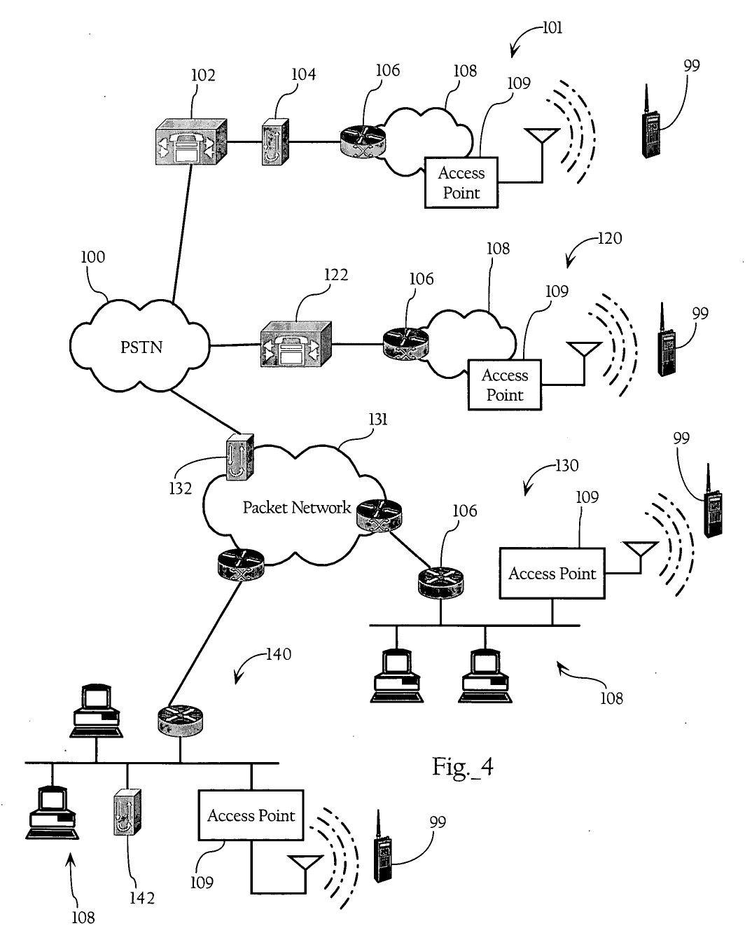

In addition, FIG. 4 illustrates various VoIP over WLAN deployment architectures. For example, according to a first VoIP over WLAN deployment 101, analog PBX system 102 connects to the Public Switched Telephone Network (PSTN) 100. Dual-mode wireless client 99, for example, logically connects to a VoIP gateway 104 via a router or switch 106 and access point 109 associated with network 108. In a second deployment architecture 120, a VoIP PBX/gateway 122 connects the network 108 to PSTN 100. In a third deployment architecture 130, network 108 supports a connection to a remote gateway/PBX 132 accessible over packet network 131. Packet network 131 can be any suitable packet-based network such as the Internet, ATM network, a Frame Relay network, and/or any combination of the foregoing network types. In a fourth deployment architecture 140, trunk-side VoIP/signalling gateway 142 supports interoffice voice calls over packet network 131. Of course, one skilled in the art will recognize that a large variety of VoIP over WLAN deployment architectures are possible.

B. Border Access Points and Border Information

Border access points 72a, 72b are configured to provide information that, in one implementation, facilitates mobility operations implemented by dual-mode wireless devices, such as dual-mode cellular phones and personal digital assistants. In one implementation, the information transmitted by border access points 72a, 72b merely indicates that the transmitting access point is a border access point. This information allows a mobile station that receives this information to determine that the transmitting access point is located proximally to a portal and/or the radio coverage boundary associated with the corresponding WLAN infrastructure. In one implementation, the border information can indicate whether the border access point is proximal to a portal (for example, by setting a corresponding flag), or merely proximal to the perimeter of a coverage area for a WLAN infrastructure where the coverage area has no defined points of ingress or egress. In one implementation, non-border access points 74 can also be configured to transmit an identifier indicating their status. For example, non-border access points 74 can transmit beacon frames including a non-border AP identifier. This information allows dual-mode wireless client 99 at initialization for example to determine that, although it does not currently detect a border access point, it is within a WLAN infrastructure that supports the border access point functionality and therefore can make certain assumptions in its selection of network access modes. In one implementation, a non-border access point may include a measure of the number of access points between it and a border access point. For example, this information could provide a simple count of the access points that would be encountered on a direct walk on the shortest path from the current location to the border or egress of the service area. In one implementation, information transmitted by border access points 72a, 72b indicate a zero as the count of access points to the border. This information can be used to simplify the velocity calculation in the dual-mode client 99, so that it can simply note whether it is seeing this count increase or decrease and whether the count is near zero. Another implementation includes access points 75 deployed “across” or outside the border of the coverage area 62 (see FIG. 1) in addition to border access points 72a, 72b. In one implementation, access points 75 across the border 62 would advertise a negative value as the count to the service border. For example, an application of this would be to deploy border access points at the doorways (or other portals) to a building and also have access points 75 deployed outside on the sidewalk or parking lot to the building.

Border access points 72a, 72b may also be configured to provide a variety of information that facilitates or enhances the mobility operations of dual-mode wireless client 99. For example, as discussed more fully below, border access points 72a, 72b may further provide affiliate information relating to supported cellular networks or other interoperability information, call control or signaling information, and geographic or location information.

In one implementation, the border information provided by the border access points 72a, 72b is contained in the beacon and/or probe response frames transmitted by the border access points 72a, 72b as part of their normal operation. In one implementation, a reserved bit or flag in the beacon and probe response frames could be set to indicate that the transmitting access point is a border access point. The beacon and probe response frames corresponding to the IEEE 802.11 protocol are extensible with a data structure called an information element. An information element is a data structure that is of the type-length-value format. In one implementation, the border information discussed above can be appended to the beacon and/or probe response frames as an information element. In one implementation, a single information element can contain all border information types (e.g., affiliate information, call control information, geographic information, etc.). In another implementation, a separate information element corresponds to each border information type.

Affiliate Information

Affiliate information, in one implementation, is information relating to the cellular networks supported by or associated with the WLAN infrastructure including the border access points 72a, 72b. For example, the affiliate information may identify the cellular network providers (e.g., Sprint®, Cingular®, AT&T Wireless®, Verizon®, etc.) that support handoffs between the cellular network and the WLAN infrastructure. This allows dual-mode wireless client 99, for example, to determine whether the handoff of a voice call, for example, between the cellular network and the WLAN can be accomplished. Dual-mode wireless client 99, in one implementation, can also use this information in selecting an access mode for a voice call.

Call Control Information

In one implementation, border access points 72a, 72b provide call control information that facilitates VoIP over WLAN sessions. In one implementation, the call control information comprises the network address of SIP server 70 or other call signaling/routing node accessible over the WLAN infrastructure. In one implementation, the call control information may also include identifiers for the protocols and/or handshake mechanisms supported by the call signaling node. For example, the call control information may indicate that the call signaling/routing node implements the SIP protocol, the H.323 protocol, and the like. The call control information may further indicate that the call signaling node requires authentication. In addition, call control information may also include information about the gateway for call signaling and phone registration with the cellular provider that can be carried in the beacon and probe response.

Location Information

Border access points 72a, 72b, in one implementation, convey geographic location information allowing mobile stations to, for example, compute their locations relative to a portal 91a or 91b . In one implementation, the location information includes: 1) the location of the transmitting access point, and 2) the location of the other border access points whose coverage areas overlap with the corresponding portal. The locations of the border access points can be expressed as coordinate locations relative to the corresponding portal. In another implementation, the border access point locations can be expressed relative to an arbitrarily-defined origin. In another implementation, the origin itself can be defined relative to global geographic coordinates (e.g., latitudinal and longitudinal coordinates). In such implementations, the location information further comprises the location coordinates of the corresponding portal.

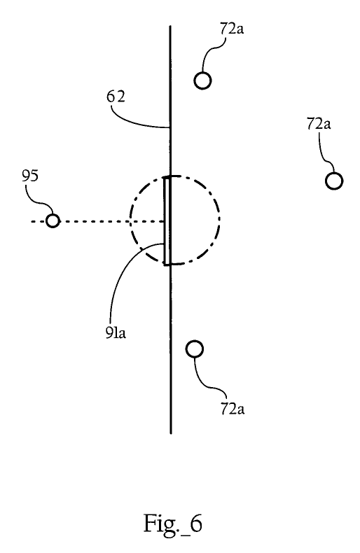

With knowledge of the locations of the border access points and the portal, a wireless client may locate itself relative to the portal by measuring the signal strength of frames received from the border access points and computing its location. In one implementation, the location information may further include orientation of the portal, such as coordinate location 95 (see FIG. 6) outside the physical space 62 and oriented in a direction orthogonal to the portal 91a. This information allows dual-mode wireless client 99 to determine whether its current location is inside or outside of the portal. Furthermore, similar orientation information, such as coordinate locations for a point or points on the perimeter, or outside, of an intended coverage area can also be provided to allow the dual-mode wireless client 99 to locate itself relative to the perimeter of an intended area of WLAN radio coverage or some other arbitrarily defined boundary.

C. Dual-Mode Wireless Client

As discussed herein, dual-mode wireless client 99 can use the border information transmitted by border access points 72a, 72b in connection with mobility-related operations, such as selecting a network type or domain upon initiation of a network application, such as a VoIP client. In one implementation, dual-mode wireless client 99 discards or ignores the border information if the strength of the signal carrying the border information is below a threshold signal strength. The inclusion of border information in beacon and probe response frames allows dual-mode wireless client 99 to obtain the information during normal 802.11-related functions, such as detecting and processing beacon frames and probe response frames. The hardware and software implemented in a dual-mode wireless client, such as a dual-mode telephone are generally known in the art. One of ordinary skill in the art will recognize how to modify the hardware and/or software implemented on such devices to make use of the border information described herein in mobility-related operations.

In addition, as discussed herein, dual-mode wireless client 99, in one implementation, uses location information transmitted by a border access point as well as the detected signal strengths of frames transmitted by identified access points in order to estimate its current location. In one implementation, dual-mode wireless client 99 makes use of the signal strength detection functionality residing on a wireless network interface chip set. For example, the IEEE 802.11 standard defines a mechanism by which RF energy is measured by the circuitry (e.g., chip set) on a wireless network adapter or interface. The IEEE 802.11 protocol specifies an optional parameter, the receive signal strength indicator (RSSI). This parameter is a measure by the PHY layer of the energy observed at the antenna used to receive the current packet or frame. RSSI is measured between the beginning of the start frame delimiter (SFD) and the end of the PLCP header error check (HEC). This numeric value, in some implementations, is an integer with an allowable range of 0-255 (a 1-byte value). Other chipsets only provide a 4-bit value. Typically, 802.11 chip set vendors have chosen not to actually measure 256 different signal levels. Accordingly, each vendor's 802.11-compliant adapter has a specific maximum RSSI value (“RSSI_Max”). Therefore, the RF energy level reported by a particular vendor's wireless network adapter will range between 0 and RSSI_Max. Resolving a given RSSI value reported by a given vendor”s chip set to an actual power value (dBm) can be accomplished by reference to a conversion table. In addition, some wireless networking chip sets actually report received signal strength in dBm units, rather than or in addition to RSSI.

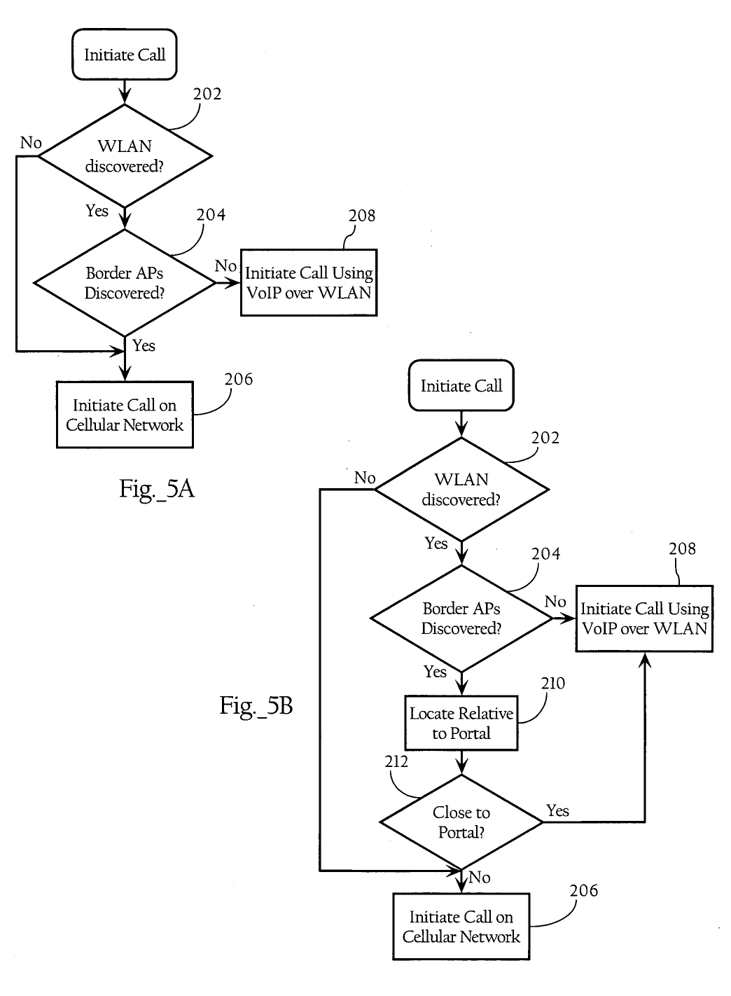

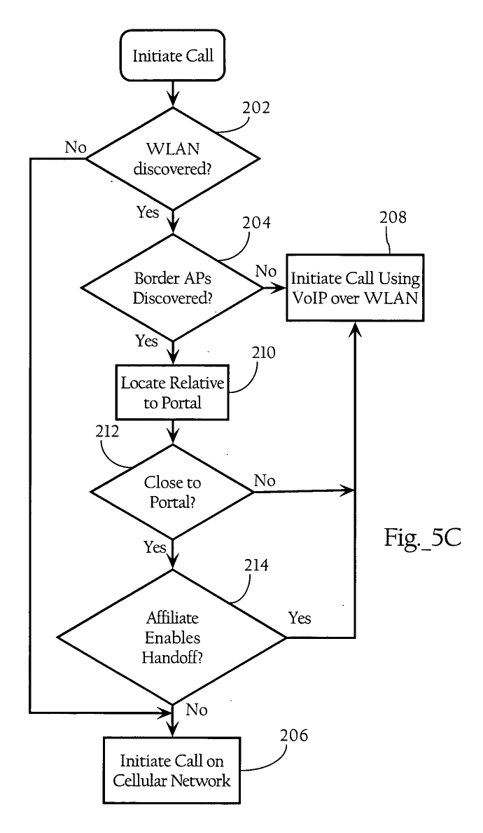

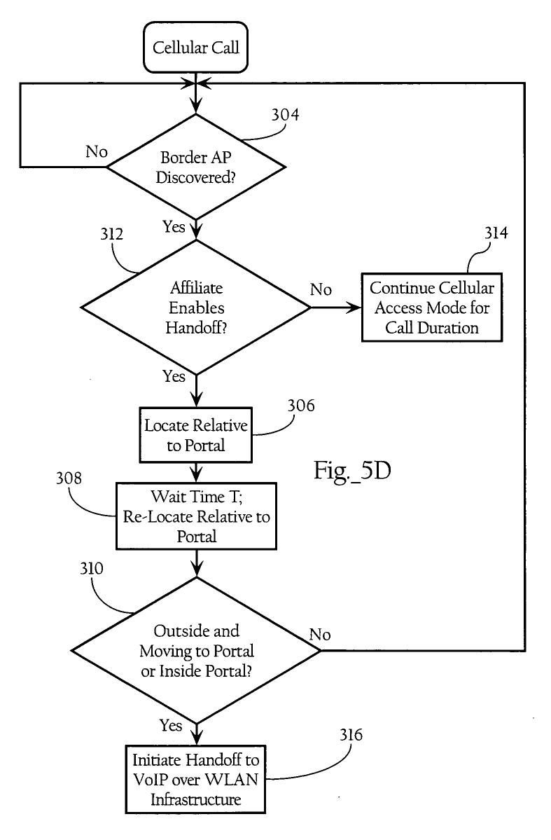

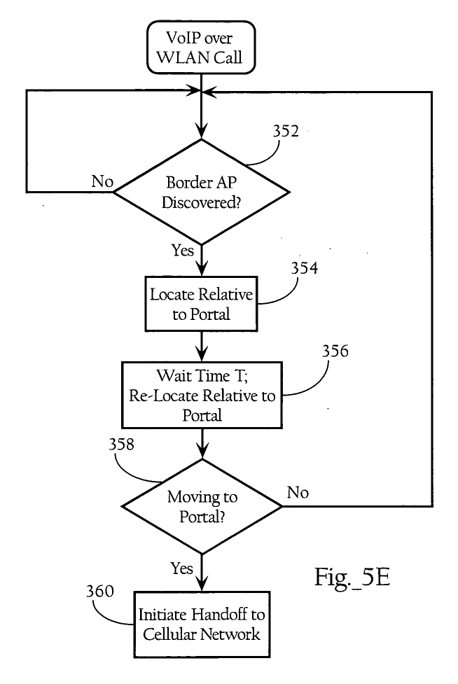

FIG. 5A sets forth a method, according to one implementation of the present invention, where border access point information can be used in selecting an access mode (e.g., cellular network v. WLAN) upon initiation of a given call. Upon initiation of a call, dual mode wireless client 99 determines whether a WLAN has been discovered (202) and whether a border access point has been discovered (204). As discussed above, dual-mode wireless client 99 can make this determination by processing beacon and probe response frames for border access point identifiers and the like. As FIG. 5A illustrates, dual-mode wireless client 99 can be configured to initiate a voice call session using the WLAN infrastructure (208), unless a border access point has been discovered (204). In this instance, dual-mode wireless client 99 initiates the call on the cellular network. As one skilled in the art will recognize, however, this is one possible use of the border information provided by the border access points 72a, 72b.

FIG. 5B illustrates a method, according to another implementation of the present invention, that also uses location information provided by border access points in selecting a network access mode upon initiation of a call. Similar to the method illustrated in FIG. 5A, if dual-mode wireless client 99 discovers a border access point (204), it computes its estimated location using the signal strength information as detected during receipt of frames transmitted by access points whose location is identified in the border information (210). As FIG. 5B illustrates, if the estimated location is within a threshold distance of the corresponding portal 91a (212), dual-mode wireless client 99 initiates the contemplated call on the cellular network (206). Otherwise, dual-mode wireless client 99 initiates the call using the WLAN infrastructure (208). As one skilled in the art will recognize, various modifications are possible. For example, dual-mode wireless client 99 may be configured to employ the method illustrated in FIG. 5B unless signal strength information for a sufficient number of access points is not received in order to triangulate or otherwise estimate location. In this circumstance, dual-mode wireless client 99 may be configured to implement the method illustrated in FIG. 5A.

FIG. 5C illustrates a method, according to another implementation of the invention, that incorporates affiliate information in the selection of a network access mode for initiating a voice call session. According to the selection logic of FIG. 5C, dual-mode wireless client 99 may initiate the call using the VoIP over WLAN infrastructure, if the cellular network provider associated with the dual-mode wireless client 99 supports handoffs of active voice sessions between the cellular network and the WLAN (214). In other implementations, dual-mode wireless client 99 can be configured to select the cellular network to initiate all voice calls (as the sole decisional criteria) if the affiliate information indicates that handoffs are not supported.

FIG. 5D provides a method, according to one implementation of the invention, directed to deciding whether to initiate the handoff of an active voice session over a cellular network to a detected WLAN infrastructure. As illustrated below, in one implementation, the handoff determination is based in part on affiliate information and the user”s trajectory relative to an identified portal. As FIG. 5D illustrates, dual-mode wireless client 99, in one implementation, may discover one or more border access points (304), such as border access points 72a, as the user approaches portal 91a. If one or more border access points is discovered (304), dual-mode wireless client 99, in one implementation, uses the affiliate information provided in the border information to determine whether handoff of the instant voice session would be successful (312). If not, dual-mode wireless client 99 continues in the cellular access mode for the duration of the voice session (314). If handoff is enabled however, dual-mode wireless client 99 computes its estimated location relative to an identified portal (306). Dual-mode wireless client 99, in one implementation, then waits a period of time (T) during which it receives additional beacon or other frames from the detected border access points, and then uses this updated signal strength information to re-compute its estimated location (308). Dual-mode wireless client 99 compares its first estimated location (306) to the second estimated location (308) to determine the user”s trajectory relative to the identified portal. For example, using the location information provided by the border access points 72a, for example, dual-mode wireless client 99 may determine that the user is outside, but moving toward, portal 91a. In one implementation, if the user is outside and moving toward, or inside of, an identified portal (310), dual-mode wireless client 99 then initiates the operations required to handoff the voice session to the WLAN infrastructure (316). For example, dual-mode wireless client 99 may associate with a selected access point, and contact SIP server 70 or other call control node to set up the logical connections required for the call session handoff. The exact handoff operations will depend on the cellular, VoIP, mobility and/or call signaling protocols employed.

FIG. 5E sets forth a method, according to an implementation of the invention, directed to determining whether to initiate a handoff of an existing VoIP over WLAN session to a cellular network. In one implementation, if dual-mode wireless client 99 discovers a border access point (352), it estimates its location relative to the portal identified by the border access point (354). In one implementation, dual-mode wireless client 99 waits a period of time and recomputes its location based on refreshed signal strength information in order to compute a trajectory relative to the portal (356). If dual-mode wireless client 99 detects that it is moving to the portal (358), it, in one implementation, initiates operations that would allow for handoff of the existing call session to the cellular network (360).

The invention has been explained with reference to specific embodiments. For example, although the embodiments described above operate in connection with handoff determinations between a WLAN network and a cellular network, the present invention can be used in connection with mobility operations between a first WLAN domain and a second WLAN domain. In addition, while embodiments of the present invention have been described as operating in connection with IEEE 802.11 networks, the present invention can be used in connection with any WLAN environment. Other embodiments will be evident to those of ordinary skill in the art. It is therefore not intended that the invention be limited except as indicated by the appended claims.

What is claimed is:

1. A wireless network access point operative to facilitate mobility operations between a first network associated with a first coverage area and a second network, comprising
a wireless transceiver;
a control unit coupled to the wireless transceiver, wherein the control unit is operative to cause the wireless transceiver to transmit border information,
wherein the border information indicates that the wireless network access point is proximal to the perimeter of the first coverage area.

2. The wireless access point of claim 1 wherein the first coverage area includes a portal, and wherein the border information indicates that the wireless network access point is proximal to the portal.

3. The wireless access point of claim 1 wherein the border information further comprises affiliate information identifying at least one cellular network with which handoffs with the first network can be accomplished.

4. The wireless access point of claim 1 wherein the border information further comprises call controller information identifying a call control node.

5. The wireless access point of claim 4 wherein the call controller information identifies a network address of the call control node.

6. The wireless access point of claim 5 wherein the call controller information identifies a supported protocol implemented by the call control node.

7. The wireless access point of claim 4 wherein the call control node is a SIP server.

8. The wireless access point of claim 4 wherein the call control node is a VoIP gateway.

9. The wireless access point of claim 1 wherein the border information further comprises location information identifying the locations of the wireless network access point and at least two other border access points.

10. The wireless access point of claim 2 wherein the border information further comprises location information identifying the locations of the wireless network access point and at least two other border access points.

11. The wireless access point of claim 10 wherein the location information further identifies the location of the portal.

12. The wireless access point of claim 11 wherein the location information further includes orientation information associated with the portal.

13. The wireless access point of claim 12 wherein the orientation information comprises a coordinate location of a point outside of the portal.

14. The wireless access point of claim 13 wherein the coordinate location is oriented orthogonal to the portal.

15. The wireless access point of claim 1 wherein the control unit is operative to implement a wireless network protocol.

16. The wireless access point of claim 15 wherein the wireless network protocol is the IEEE 802.11 protocol.

17. The wireless access point of claim 1 wherein the border information is contained in a wireless frame.

18. The wireless access point of claim 16 wherein at least some of the border information is formatted as an information element in a wireless frame.

19. The wireless access point of claim 17 wherein the wireless frame is a beacon frame.

20. The wireless access point of claim 17 wherein the wireless frame is a probe response frame.

21. A dual-mode wireless client operative to communicate, in a first access mode, with a cellular network and, in a second access mode, with a wireless local area network comprising a plurality of access points distributed over a coverage area, comprising
a processor;
a memory;
a wireless network interface for communication with a wireless local area network;
a cellular network interface for communication with a cellular network;
a network software application, stored in the memory, comprising instructions operable to cause the processor and the dual-mode wireless client to transmit and receive data over a selected interface; and
access mode selection logic comprising instructions operable to cause the processor to
select, responsive to operation of the network software application, the wireless network or cellular network interface for initiation of a session based in part on border information received from one or more wireless network access points, wherein the border information indicates whether a wireless network access point is proximal to the perimeter of the first coverage area.

22. The dual-mode wireless client of claim 21 wherein the access mode selection logic is operative, through the wireless network interface, to discover a wireless local area network during operation of the network software application over the cellular network interface.

23. The dual-mode wireless client of claim 22 wherein the access mode selection logic is operative to handoff an existing session between a wireless area network and a cellular network based on border information received from one or more access points.

24. The dual-mode wireless client of claim 21 wherein the access mode selection logic is implemented as a software application stored in the memory.

25. The dual-mode wireless client of claim 21 wherein the access mode selection logic is implemented in hardware.

26. The dual-mode wireless client of claim 21 wherein the network software application is a VoIP client application.

27. The dual-mode wireless client of claim 21 wherein the network software application is a browser application.

28. The dual-mode wireless client of claim 21 wherein the coverage area includes a portal, and wherein the border information indicates that the wireless network access point is proximal to the portal.

29. The dual-mode wireless client of claim 21 wherein the border information further comprises affiliate information identifying at least one cellular network with which handoffs with the wireless local area network can be accomplished

30. The dual-mode wireless client of claim 21 wherein the border information further comprises call controller information identifying a call control node.

31. The dual-mode wireless client of claim 30 wherein the call controller information identifies a network address of the call control node.

32. The dual-mode wireless client of claim 31 wherein the call controller information identifies a supported protocol implemented by the call control node.

33. The dual-mode wireless client of claim 30 wherein the call control node is a SIP server.

34. The dual-mode wireless client of claim 30 wherein the call control node is a VoIP gateway.

35. The dual-mode wireless client of claim 21 wherein the border information further comprises location information identifying the locations of the wireless network access point and at least two other border access points.

36. The dual-mode wireless client of claim 28 wherein the border information further comprises location information identifying the locations of the wireless network access point and at least two other border access points.

37. The dual-mode wireless client of claim 36 wherein the location information further identifies the location of the portal.

38. The dual-mode wireless client of claim 37 wherein the location information further includes orientation information associated with the portal.

39. The dual-mode wireless client of claim 38 wherein the orientation information comprises a coordinate location of a point outside of the portal.

40. The dual-mode wireless client of claim 37 wherein the access mode selection logic is operative to estimate the location of the dual-mode wireless client relative to the portal.

41. The dual-mode wireless client of claim 40 wherein the access mode selection logic is operative to select the wireless network or cellular network interface, at initiation or handoff of a session, based on the estimated location.

42. A method facilitating mobility between a first wireless network and a second network, comprising
deploying a plurality of wireless access points over a coverage area, wherein the coverage area is defined by a portal; and
configuring an access point located proximally to the portal to transmit border information indicating that the at least one access point is proximal to the portal.

43. The method of claim 42 further comprising
configuring a second access point to transmit information indicating the number of access points on a selected path between the second access point and the access point located proximally to the portal.

44. A wireless network access point operative to facilitate mobility operations between a first network associated with a first coverage area and a second network, wherein the first coverage area includes a portal and at least one border access point located proximally to the portal, comprising
a wireless transceiver;
a control unit coupled to the wireless transceiver, wherein the control unit is operative to cause the wireless transceiver to transmit information indicating the number of access points on a selected path to a selected border access point.
